(19) United States
(12) Patent Application Publication
(10) Pub. No.: US 2001/0053315 A1
(43) Pub. Date: Dec. 20, 2001

(54) Two tier trailer

(76) Inventor: Mike P. Julian, Amarillo, TX (US)

Correspondence Address: James P. Bradley, Bracewell & Patterson, L.L.P., 711 Louisiana, Suite 2900, Houston, TX, 77002, US

(21) Appl. No.: 09/863,192

(22) Filed: May 23, 2001

Related U.S. Application Data
(60) Provisional application No. 60/206,531, filed on May 23, 2000.

(51) Int. Cl. B60P 3/06

(52) U.S. Cl. 410/4

(57) ABSTRACT

A multiple tiered cargo trailer comprised of a lower trailer deck and an upper trailer deck that permits the upper deck to lower itself down onto the lower deck for loading. The trailer's lower deck is suspended on an axle assembly with wheels that will facilitate transportation of the trailer. Additionally, the lower deck also contains a yoke extending to the towing vehicle that is adapted to mate to a hitch. The trailer contains pivotally attached support legs extending upwards from the lower trailer deck to the upper trailer deck. These support legs permit the upper deck to be lowered to the lower deck by moving the upper deck rearward. The activator to lower and raise the upper deck to and from the lower deck includes winch mast, winch, cable, and pulley systems.

### BACKGROUND OF INVENTION

1. Field of Invention

The present invention relates to a trailer for towing behind a towing vehicle. Specifically, the present invention provides a novel method for a multiple tiered trailer to load it upper trailer deck from the ground. Additionally, the present invention provides an improved multiple tiered trailer that does not limit the width of the cargo that may be placed upon the upper trailer deck.

2. Description of the Prior Art

Vehicle cargo trailers have been widely used to provide additional cargo carrying capacity for the transportation of large loads that may be too large or ill suited to be transported in the vehicle itself. Traditionally, such cargo trailers are either one tier or two tier trailers with a wheel assembly that permits transportation of the trailer when attached to the tow vehicle. The loading of single tier trailer is accomplished through the use of loading ramps. The multiple tier trailers market has traditionally offered two tiered cargo trailers that consists of a lower trailer deck and an upper trailer deck which both may be used to transport various loads. One two tiered trailer currently offered in the market use a lift cable pulley system to load the upper trailer deck. The upper trailer deck is supported by stationary posts that extend from the lower trailer deck. The loading of the upper trailer deck is accomplished by using the cable pulley system to slide the upper trailer deck, down the support post to land upon the lower trailer deck where it can be loaded with a ramp. A disadvantage of this type of trailer is encountered when the cargo to be loaded upon the upper trailer deck has a width greater than the width of the support posts. These posts limit the available width that the upper deck cargo may contain.

### SUMMARY OF INVENTION

The present invention is a multiple tiered cargo trailer comprised of a lower and an upper trailer deck trailer that permits the upper trailer deck to lower itself down onto the lower trailer deck for loading. The lower trailer deck is suspended on an axle assembly with wheels that will facilitate transportation of the trailer. The lower trailer deck also contains a yoke extending to the towing vehicle that is adapted to mate to a ball hitch. The lower trailer deck contains support legs or posts extending upwards from its perimeter to the upper trailer deck. These support legs are pivotally attached to the lower and upper trailer deck. The upper trailer deck can be lowered to the lower trailer deck by moving the upper trailer deck rearward to pivot on the support legs. The mechanical means to lower and raise the upper trailer deck to and from the lower trailer deck can be accomplished through the use of a winch mast, winch, cable, and pulley system.

As it will be realized the present invention is capable of other different embodiments and its details are capable of different modifications without departing from the invention. Accordingly, the drawings and descriptions will be regarded as illustrative in nature and not as restrictive.

### BRIEF DESCRIPTION OF THE DRAWINGS

FIG. 1 is a side view of a two tiered trailer constructed in accordance with this invention loaded with an automobile on the lower trailer deck and several all terrain vehicles on the top deck.

FIG. 2 is a perspective view of the front of the trailer of FIG. 1.

FIG. 3 is a perspective view of the rear of the trailer of FIG. 1, showing the upper trailer deck is being lowered toward the lower trailer deck.

FIG. 4 is a side view of the trailer of FIG. 1, shown with this invention with the upper trailer deck lowered onto the lower trailer deck.

FIG. 5 is an end view of the trailer of FIG. 1.

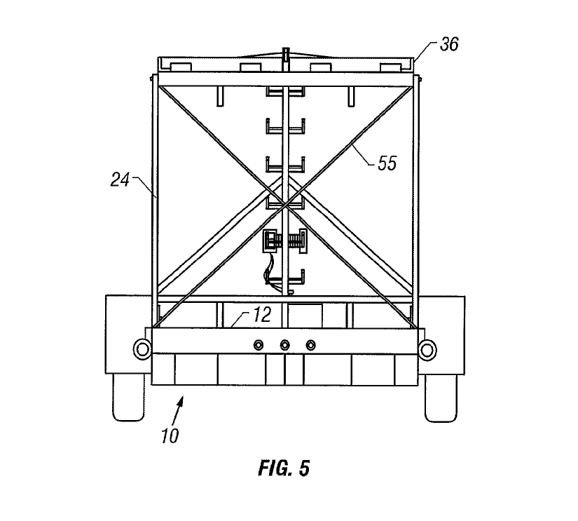

### DESCRIPTION OF THE PREFERRED EMBODIMENT

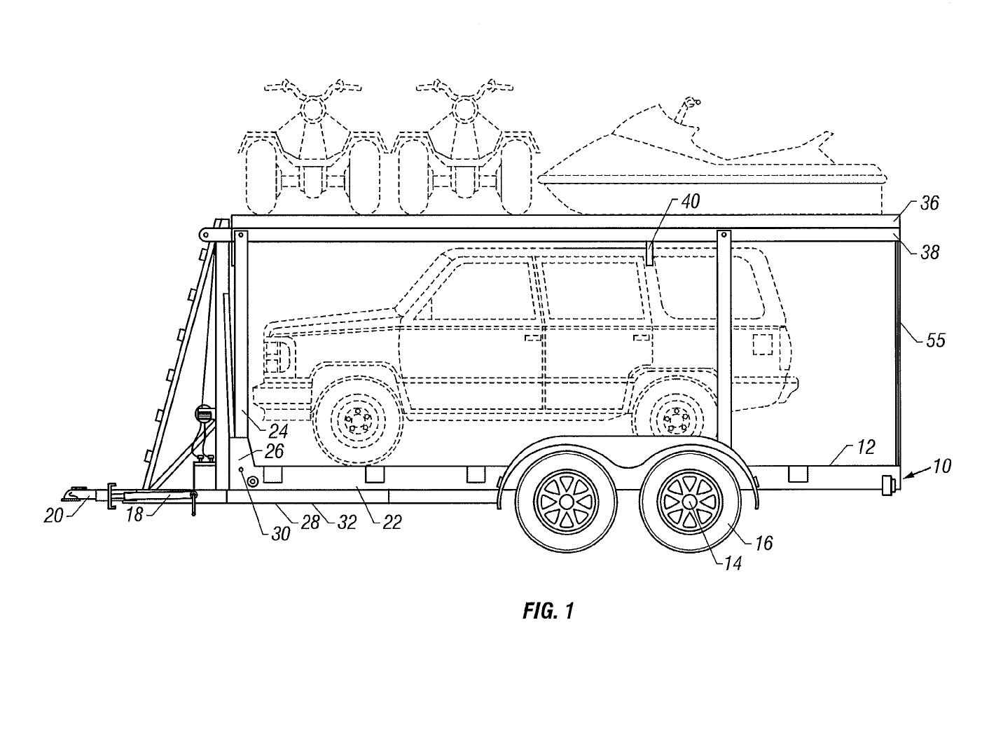

Referring first to FIG. 1, a two tiered trailer 10 constructed in accordance with this invention generally has a planar lower trailer deck assembly 12 suspended on at least one axle assembly 14. Axle assemblies 14 have wheels 16 on each end which allow trailer 10 to roll. Lower deck assembly 12 has a generally Y-shaped yoke 18 extending forward and converging in a coupling 20 adapted to mate to a conventional ball hitch. Lower deck assembly 12 is constructed having heavy gauge box tubing around its outer edges to form a rigid perimeter frame 22. Perimeter frame 22 is tied in directly to yoke 18 and axle assemblies 14 as part of the structural framework of trailer 10.

Four support legs 24 are pivotally joined to perimeter wall 22 near the corners of deck 12 by mounting tangs 26. Mounting tangs 26 are rigidly secured to the top surface of perimeter frame 22, each formed by a pair of parallel flange members 28 extending upwardly therefrom. Support legs 24 are heavy gauge box tubing, and are inserted between parallel flange members 28 of each tang 26. Each leg 24 is pivotally retained in tang 26 by a transverse pin 30 which passes from one flange member 28 through leg 24 and out through the adjacent flange member 28. For ease of construction and to minimize component costs, pin 30 is preferably a bolt sized to withstand the shear forces imposed by leg 24 and tang 26. Leg 24 is mounted between flange members 28 so that it can rotate in a plane parallel to flange members 28 to a point at which it is substantially parallel to the top surface of perimeter frame 22. A transverse support member 32 spans the front of deck assembly 12 and ties the front flange members 28 together to increase the lateral stiffness of the front tangs 26. Transverse support member 32 is itself joined to perimeter frame 22 by vertical members 34.

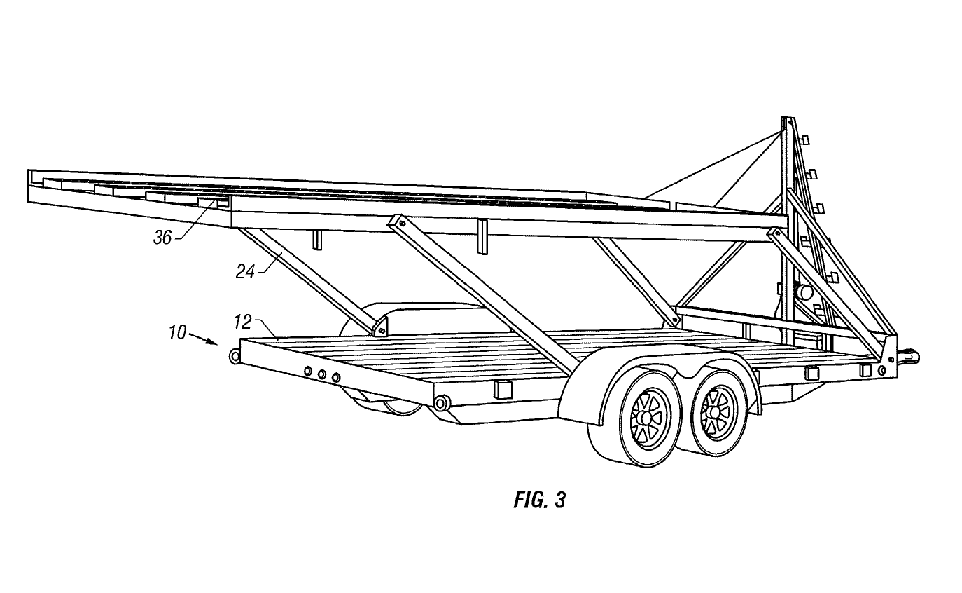

An upper deck assembly 36 is mounted to an upper end of support legs 24. Upper deck assembly 36 has a perimeter frame 38 similar to perimeter frame 22 of lower deck assembly 12, and legs 24 are mounted with a single transverse pin 30 or bolt through upper frame 38. Upper deck assembly 36 can be lowered to lower deck assembly 12 by moving upper deck 36 rearward to pivot on support legs 24 (FIG. 3). Support legs 24 pivot on pins 30 to hold upper deck assembly 36 parallel to lower deck assembly 12, and thus horizontal, throughout the entire range of motion. Upper frame 38 has a plurality of stands 40 extending downwardly therefrom and spaced to support upper deck 36 on lower deck 12 when upper deck 36 is in its lowest position. Preferably this lowest position is such that upper deck 36 is as close as possible to lower deck 12 without impacting the front support legs 24 with the rear support legs 24.

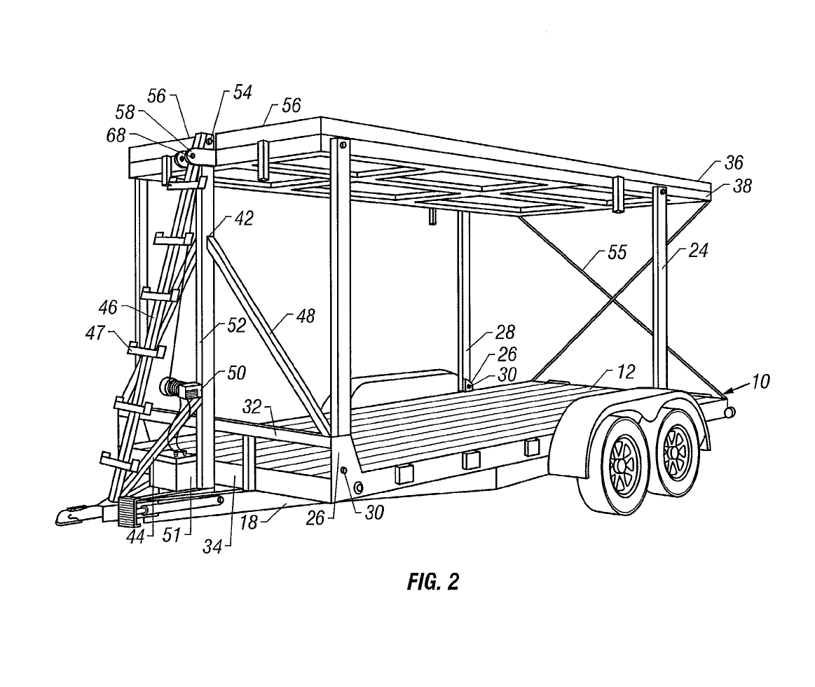

Referring to FIG. 2, a winch mast 42 extends upward from a front edge of frame 22 and is tied into transverse support 32. Winch mast 42 has a lower front strut 44 which extends from a point on mast 42 downward toward the point at which yoke 18 converges and an upper front strut 46 which extends from a point near the top of mast 42 downward toward the same point, each to stiffen mast 42 in a plane that runs from front to rear of trailer 10. Upper strut 46 may be configured with rungs 47 to aid access to upper deck 36. Additional side struts 48 extend from mast 42 laterally downward to transverse support 32 to stiffen mast 42 laterally. Further structural reinforcement may be added as needed. A winch 50, preferably electric, is mounted to winch mast 42 above strut 44 and a battery 51 is mounted nearby on yoke 18. Winch 50 has a cable 52 which is routed up winch mast 42 and over a mast pulley 54 at the top of mast 42. Cable 52 then extends around a block pulley 56 mounted to frame 38 of upper deck assembly 36, and back to mast 42. As winch 50 is spooled out, upper deck assembly 36 can pivot rearward on legs 24 toward lower deck assembly 12 (FIG. 3). As winch 50 is spooled in, upper deck assembly 36 is drawn toward winch mast 42, and will pivot from a lower position to a full upright position where frame 38 abuts winch mast 42. As it pivots, upper deck assembly 36 always remains parallel to lower deck assembly 12. Legs 24 also remain parallel to each other while pivoting. Also, in its full upright position, upper deck assembly 36 is braced against lateral movement by a removable X-brace 55 (FIG. 1) connecting upper and lower decks 36, 12.

When in the most upright position, upper deck assembly 36 can be locked against mast 42 to prevent upper deck assembly 36 from pivoting rearward and down. Upper frame 38 has flanges 58 which straddle mast 42 when in the upright position. A bolt 60 is placed through flanges 58 trapping mast 42 is between upper deck assembly 36 and bolt 60.

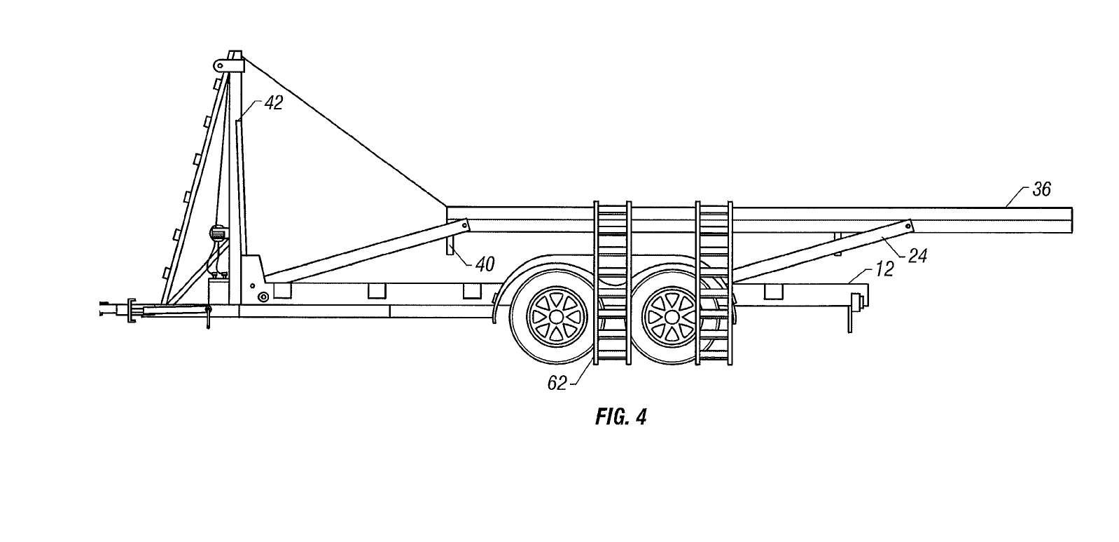

Referring to FIG. 4, ramps 62 for loading and unloading the upper and lower deck assemblies 36, 12 are stored under lower deck assembly 12 on shelves (not shown). Ramps 62 are sized to span between the ground and both lower deck 12 and upper deck 36 when in its lowest position.

In use, bolt 60 is removed from flanges 60 and X-brace 55 is removed. Winch 50 is spooled out and upper deck assembly 36 pivots rearward and downward toward lower deck assembly 12 until supported on stands 40. Ramps 62 are removed from under lower deck 12 and leaned to span between the ground and upper deck 36. Upper deck 36 is loaded, ramps 62 removed, and winch 50 spooled in to lift upper deck 36 to the full upright position. Bolt 60 is reinserted through flanges 58 to secure upper deck 36 in the full upright position. Ramps 62 are then positioned to span between the ground and lower deck 12. Lower deck 12 is loaded, ramps 62 are removed and stored under lower deck 12, and X-brace 55 is reinstalled to prepare trailer 10 for towing.

The present invention provides a multiple tiered cargo trailer that can load and transport cargo having greater width than the trailer. The present invention is advantageous over current trailer because it does not lower its upper trailer deck by sliding the upper trailer deck down stationary support post, thereby, allowing for cargo that is wider than the width of the stationary support post to be loaded and carried on the trailer.

The present invention provides a multiple-tiered cargo trailer that can launch a water craft directly from the trailer into the water using a boat ramp. A watercraft on the upper trailer deck can be launched from the trailer into the water through a boat ramp when the upper trailer deck is lowered.

It should be appreciated that if changes and modifications are made to the above described embodiments without departing from the inventive concept thereof, but is intended to include all modifications that are made to the above described embodiment. Therefore it is to be understood that the form of the invention herewith shown and described is to be taken as a preferred example of the same, and that various changes in the shape, size, and arrangement of parts resorted to, without departing from the spirit of the invention or scope of the claims. The foregoing disclosure and description of the invention are illustrative and explanatory thereof, and various changes in the size, shape, materials, components, and method of operation made without departing from the spirit of the invention.

1. A multiple tiered trailer for towing comprising:
a lower trailer deck for storing objects;
support legs pivotally joined to said lower trailer deck;
an upper trailer deck for storing objects, said upper trailer deck being pivotally mounted to said support legs for movement relative to said lower trailer deck between an upper position and a lower position; and
an activator connected between said upper trailer deck and said lower trailer deck for causing movement of said upper trailer deck.

2. A multiple tiered trailer set forth in claim 1 wherein, said activator comprises of:
a winch mast extending from said lower trailer deck to said upper trailer deck; and
a winch mounted to said winch mast, wherein said winch, when spooling, will cause said support legs and said upper trailer deck to pivot towards or away from said lower trailer deck assembly.

3. A multiple tiered trailer set forth in claim 1 wherein, said lower trailer deck is suspended on at least one axle assembly having wheels that facilitate the transportation of said multiple tiered trailer.

4. A multiple tiered trailer set forth in claim 1 wherein, four of said legs, two at the forward ends of said upper trailer deck and said lower trailer deck and two at the rear ends of said upper trailer deck and said lower trailer deck.

5. A multiple tiered trailer set forth in claim 1 wherein, said upper trailer deck moves rearward while being lowered from said upper position to said lower position.

6. A multiple tiered trailer set forth in claim 1 wherein, said upper trailer deck remains parallel to said lower trailer deck while being lowered to said lower position.

7. A multiple tiered trailer set forth in claim 1 further comprising a plurality of stands extending downward from said upper trailer deck for contact with said lower trailer deck while in said lower position.

8. A multiple tiered trailer set forth in claim 1 further comprising a removable diagonal brace mounted between the comers of said upper trailer deck and said lower trailer deck at the rearward ends.

9. A multiple tiered trailer set forth in claim 1 wherein, said support legs are substantially perpendicular to said upper trailer deck and said lower trailer deck while in said upper position and substantially parallel to said upper trailer deck and said lower trailer deck while in said lower position.

10. A multiple tiered trailer for towing comprising:
an axle assembly having wheels;
a lower trailer deck mounted to said axle assembly and having four corners;
an upper trailer deck having four corners;
a support leg extending between said upper trailer deck and said lower trailer deck at each corner having an upper end and a lower end pivotally mounted to said upper trailer deck and said lower trailer deck and each support leg being pivotally in a plane extending along a length of the trailer for moving said upper trailer deck between an upper position and a lower position relative to said lower trailer deck while remaining parallel to said lower trailer deck;
a stationary winch mast extending upward from a forward end of said lower trailer deck and connected to said upper trailer deck by a cable; and
a winch mounted to said winch mast, wherein said winch, when spooling, will cause said support legs to pivot and said upper trailer deck to move towards or away from said lower trailer deck.

11. A multiple tiered trailer set forth in claim 10 further comprising a plurality of stands extending downward from said upper trailer deck for contact with said lower trailer deck while in said lower position.

12. A multiple tiered trailer set forth in claim 10 further comprising a removable diagonal brace mounted between said comers of said upper trailer deck and said lower trailer deck at the rearward ends.

13. A multiple tiered trailer set forth in claim 10 wherein, said upper trailer deck moves rearward while being lowered from said upper portion to said lower portion.

14. A multiple tiered trailer set forth in claim 10 wherein, said legs are substantially perpendicular to said upper trailer deck and said lower trailer deck while in said upper position and substantially parallel to said upper trailer deck and said lower trailer deck while in said lower position.

15. A multiple tiered trailer set forth in claim 10 wherein, a pulley mounted to an upper end of said winch mast, said cables extending over said pulley to said upper trailer deck.

16. A method for loading a multiple tiered trailer for towing comprising the steps of:
a. pivotally mounting an upper trailer deck to a lower trailer deck by a plurality of support legs;
b. with said lower trailer deck unloaded, lower said upper trailer deck relative to said lower trailer deck by moving said upper trailer deck rearward and pivoting said support legs from an upright position to an inclined position;
c. moving objects onto said upper trailer deck;
d. moving said upper trailer deck forward and pivoting said support legs back to said upright position
e. moving objects onto said lower trailer deck.

17. A method for loading a multiple tiered trailer set forth in claim 16 wherein,
step (b) comprises of connecting a cable between a forward portion of said upper trailer deck and said lower trailer deck and playing out said cable; and
step (d) comprises of taking up the cable.

18. A method for loading a multiple tiered trailer set forth in claim 16 further comprising, after step (d) mounting a removable diagonal brace mounted between the corners of said upper trailer deck and said lower trailer deck at the rearward ends.

19. A method for loading a multiple tiered trailer set forth in claim 16 further comprising, after step (d) locking legs in a upright position.

20. A method for loading a multiple tiered trailer set forth in claim 16 further comprising,
in said upright position having said legs being substantially perpendicular to said upper trailer deck and said lower trailer deck;
in said inclined position having said legs being substantially parallel to said upper trailer deck and said lower trailer deck; and
having said upper trailer deck remaining substantially parallel while moving between said upright position and said inclined position.
